(19) United States
(12) Patent Application Publication
(10) Pub. No.: US 2004/0179016 A1
(43) Pub. Date: Sep. 16, 2004

(54) DRAM controller with fast page mode optimization

(76) Inventor: Chris Kiser, Albuquerque, NM (US)

Correspondence Address: CARSTENS YEE & CAHOON, LLP, P O BOX 802334, DALLAS, TX, 75380

(21) Appl. No.: 10/386,299

(22) Filed: Mar. 11, 2003

(51) Int. Cl. G09G 5/39

(52) U.S. Cl. 345/531

(57) ABSTRACT

A system and method for controlling memory accesses for display data. Pixel data for a display are accessed by a graphics controller having two linear counters, the first counter controlling which column is accessed by the controller, the second counter controlling which row is accessed by the controller. With each successive memory access within a predetermined set of accesses, the first counter increments. When the first counter reaches the end of the row in memory (or another predetermined counting state), the second counter increments. When the second counter increments, the controller necessarily accesses the next row of memory locations.

### BACKGROUND OF THE INVENTION

1. Technical Field

The present invention relates to the field of memory devices and systems. More specifically, the present invention relates to optimization of Fast Page Mode memory access.

2. Description of Related Art

Random access memory, or RAM, comprises memory in which data is stored in an array of transistor flip flops called storage cells. Each storage cell has a unique row and column position, which together make up the address of that storage location. One limitation in computer systems is the speed with which a processor can access data from memory. When a processor must access data within memory, a row address and column address signal is sent to the memory and the data within the accessed cell is output on a data bus.

Some applications are more data intensive than others. For example, in graphics processing there are many pixels which must be described by data in memory, so the graphics controller must make many memory accesses in a short period of time to maintain screen visual integrity.

FIG. 1 shows a block diagram of a typical computer system for a remote monitor. The computer system comprises microprocessor 102 connected to USB interface 104, graphics controller 106, and DRAM memory 108 accessible to graphics controller 106. In a preferred embodiment, the remote monitor is connected to a host computer via USB 104.

FIG. 2 shows a slightly more detailed depiction of DRAM 108 from FIG. 1. The DRAM storage cells themselves are comprised of transistors arranged into flip-flop storage configurations. Connected to DRAM are row address select (RAS) input pin 202 and column address select (CAS) input pin 204. Also shown is a representation of the address input pins 206.

A typical DRAM can have 2 row addresses, and 212 column addresses. Standard DRAM access typically comprises the steps of placing the row address of the storage cells to be accessed on the address input pins of the memory chip, placing a logic low on the row address select input pin, placing the column address of the storage cells to be accessed on the address input pins of the memory chip, and placing a logic low on the column address select input pin. This process is also referred to in this specification as putting particular row and column address pins in an “access state,” meaning that memory cell is accessed.

FIG. 3 shows this process in the form of a timing diagram. The vertical axis shows address input line, which represents the contact which determines which memory cell is put into an access state. Address input line has the row address placed thereon, and the RAS is turned to logic low. This step is required to allow access to the data in that particular row of DRAM. Next, the CAS is turned to logic low, which allows access to the data in that particular column, where the row is already lit. In the figure, the “data” line shows when access to the desired address is possible in relation to the logic of the address input pins, the RAS and the CAS. Data is only accessible at a given storage cell when both the RAS and CAS are activated (logic low, in this example), or put another way, when the address pins of the desired cell are put in an access state.

Graphics controllers are constantly accessing DRAM for display information, namely the pixels that comprise the image on the screen. The microprocessor only requires intermittent access to the DRAM, enough to keep track of what is where in the memory. In accessing a storage cell in DRAM, changing the logic signals to the various pins requires clock cycles. For example, in a 100 MHz DRAM, it takes about 10 nanoseconds to strobe the RAS or the CAS (one clock cycle). Data access speed is thus limited by the time it takes to key in a new RAS and CAS for each data element.

To increase the data access efficiency, fast page mode (FPM) access allows access to multiple columns when a given row is activated. FIG. 4 shows an example timing diagram for a fast page mode access. The address input pin inputs the row address, and the RAS is input logic low. The address input pin then inputs a plurality of column addresses, each of them located on the same row of data in the DRAM. This allows the row access line to be held low while the column access line is strobed, accessing multiple storage cells without requiring the time to re-strobe the row access line. Thus, FPM saves many clock cycles when data to be accessed is located on the same row in DRAM. FPM access requires that the row address for each memory access be checked before the access begins, to determine if the correct row is being accessed.

The control logic performs a row address comparison to determine whether data is located at the same row address as the previous data accessed. If the next address is in the same row as the previously accessed address, FPM access is used. If the next address is not in the same row as the previously accessed address, a regular (i.e., non-FPM) slower memory access is employed.

Thus, the memory controller (control logic) determines which type of memory access is appropriate before initiating the memory access. This requires an additional clock cycle for all memory accesses. However, FPM access is typically a few clock cycles faster at accessing data than standard memory access, so the overall memory performance is better for FPM access. Use of FPM requires a buffer of some sort to access multiple columns of a given row of data.

It would therefore be advantageous to have a memory system that did not require an added clock cycle for comparing the row addresses of such memory accesses.

### SUMMARY OF THE INVENTION

The present invention comprises a system for accessing random access memory. Fast Page Mode is optimized in the innovative system by alleviating the need to compare the row address for the next data point to the row address of the previously accessed data point. In a preferred embodiment, this is done by using two linear counters, one each for the row and column address of the accessed data. As the controller accesses the memory, the first counter increments the column address so that on the next memory access, the controller will get the next data point in that row but in the next adjacent column. When the first counter reaches its maximum value (which represents the end of that data row) then a carryout function increments the second counter, which represents the row of the accessed data. The first counter resets. Again, the first counter begins incrementing with each memory access until it reaches its end (or a predetermined threshold), and the carryout again increments the second (i.e., the row) counter. Using this innovative system and method, the FPM need not spend a clock cycle comparing the row addresses of the previous and next data points to be accessed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a block diagram for a conventional computer system.

FIG. 2 shows a block diagram of a DRAM storage array.

FIG. 3 shows a timing diagram of a conventional memory access.

FIG. 4 shows a timing diagram for fast page mode access.

FIG. 5 shows a block diagram of the innovative system consistent with a preferred embodiment.

FIG. 6 shows a flow chart of a memory access according to a preferred embodiment.

FIG. 7 shows a block diagram representing the innovative counting method according to a preferred embodiment.

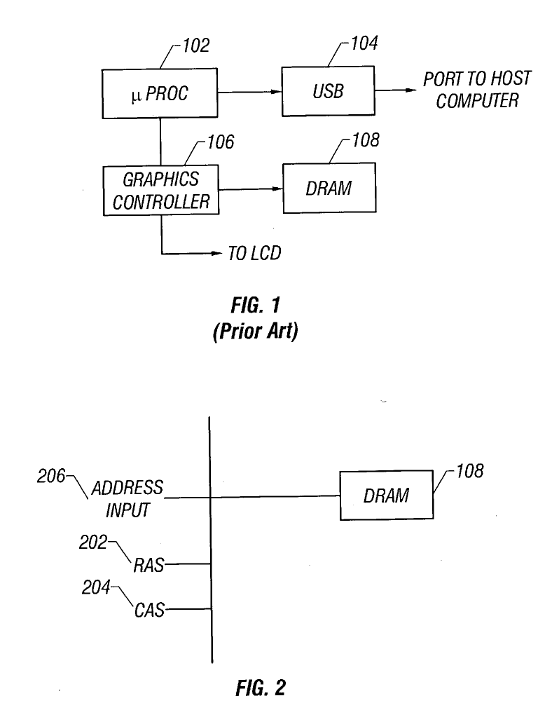

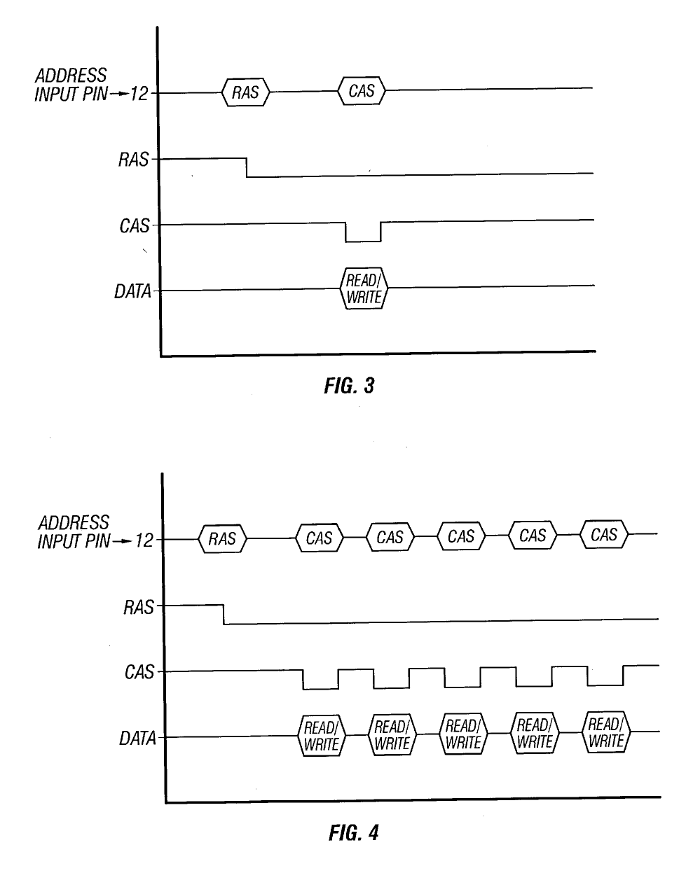

### DETAILED DESCRIPTION OF THE INVENTION

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

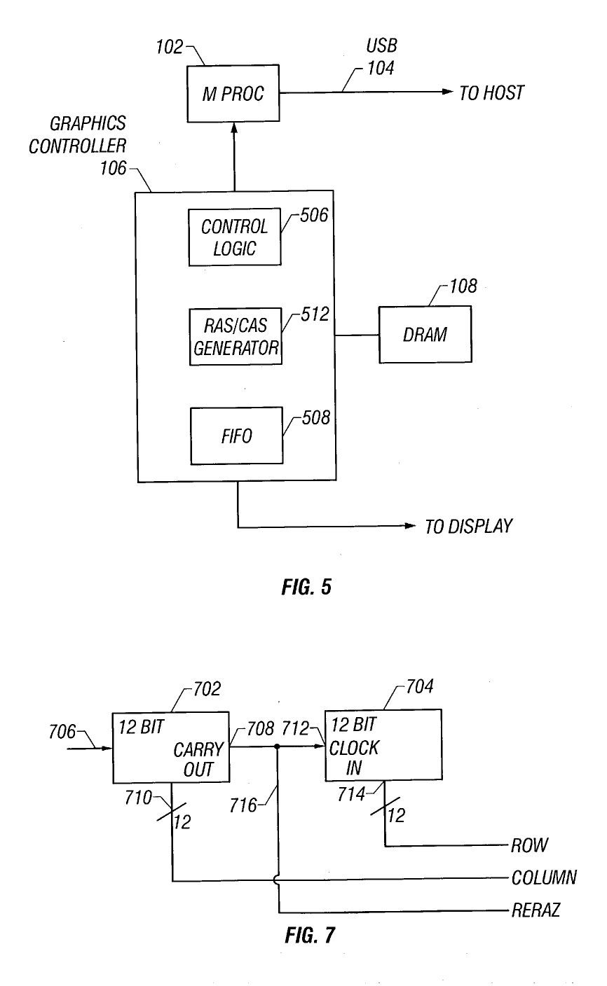

The present innovations are described with reference to the figures. FIG. 5 shows a block diagram of a graphics controller and other system components consistent with a preferred embodiment of the present innovations. Graphics controller 106 is connected to microprocessor 102, which interfaces with a host computer via USB 104. Graphics controller 106 also has access to DRAM 108 (which contains data for the display).

Within the graphics controller 106, other components are depicted. Control logic 506 is a memory controller and determines what kind of memory access is used when the processor attempts to access memory at a given address. Control logic 506 connects to DRAM 108 containing display information, for example. Also connected to DRAM 108 is fifo 508. RAS and CAS generator 512 connects to DRAM 108 as well.

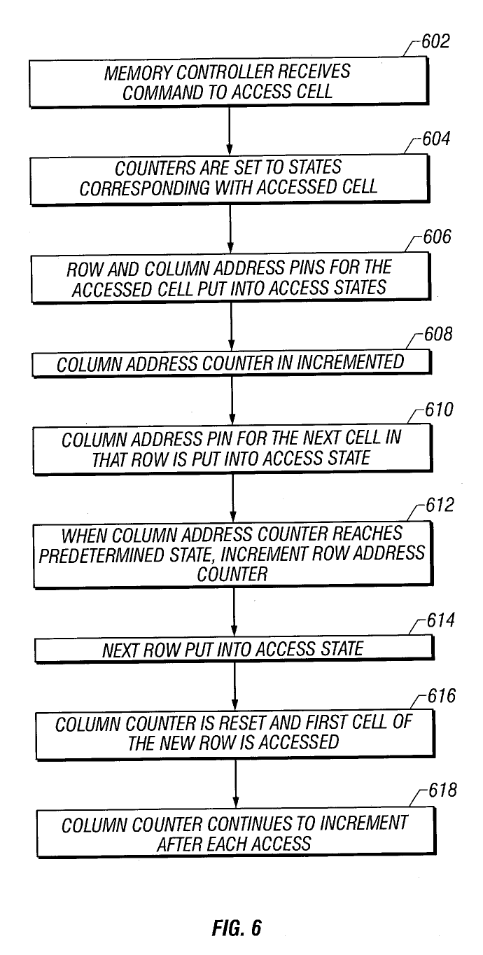

FIG. 6 shows a flow chart of the process of accessing memory in the system depicted in FIG. 5. The memory controller includes two counters, a first counter corresponding to the column of the memory cell being accessed, a second counter corresponding to the row of the memory cell being accessed. First, the memory controller receives a command to access memory at a given cell (step 602). The counters are set to respective states corresponding to this cell by changing their states to the column and row address for the cell (step 604). The row address pin corresponding to the accessed cell is therefore held in a state allowing the cells on that row to be accessed (accessed, that is, when corresponding column addresses are also held in access states), and the column address pin corresponding to the first cell being accessed is also put into an access state (step 606) and the cell is therefore accessed.

The counter corresponding to the column address is then incremented (step 608) and the next cell in that row is therefore accessed by putting the column address pin for that cell in an access state (step 610) which causes that cell to be accessed. This access does not require the use of a clock cycle to check the row address of the next cell as is required in typical FPM access. When the column address counter reaches a predetermined state (e.g., the end of the row or the end of that group of memory accesses, depending on the implementation used) the row address counter increments by one (step 612) causing the next row to be put into an access state (step 614). The column counter is reset to the first address position of the new row and that cell is accessed (step 616). The column counter continues to increment after each access and the process continues thus (step 618).

FIG. 7 shows a block diagram depicting the system of counters for accessing of the DRAM consistent with the present innovations. In typical DRAM, a 24 bit linear address is stored in a memory, indicating the address of the desired data within the DRAM (note the address size is an example only, and not intended to limit the application of the present inventions). In a preferred embodiment of the present inventive system, the 24 bit address is converted into two 12 bit linear counters one for a 12 bit row address and one for a 12 bit column address of each memory cell or storage location. FIG. 7 shows how incrementing the 24 bit address is accomplished within the innovative system.

In a preferred embodiment, an innovative FPM memory access system, the control logic does not compare the row address of a previously accessed memory site to the next memory site to be accessed. Instead, the control logic includes two linear counters. For example, in a 24 bit address system, the 24 bit address is converted into two 12 bit linear counters 702 and 704. The first counter 702 has an input 706 for receiving an increment signal, first output 708 (the carryout) connected to second counter 704 and second output 710 for sending the column address to the memory. The second counter 704 receives the input 712 from the first counter 702.

The second counter 704 also has an output 714 for sending the row address to the memory input.

The carryout line 708 also connects to a line 716 that indicates when to restrobe the row address line.

This part of the control logic receives an increment signal and outputs row and column addresses. Second output for the first counter indicates the column address site, while the output of the second counter indicates the row address site.

When graphics data is accessed by the processor in this innovative system, the two counters are employed to increment the row address and column address accessed by the controller. The first address is input, which sets the counters to places that correspond to the row and column address of the accessed data point. In a preferred embodiment, the controller automatically looks for the next memory access at that same row but in the next column address, using the counting states of the counters to control which memory address is accessed.

As each new data is accessed, the first counter 702 increments one, changing the column address accessed as shown on the second output 710 of the first counter 702. After each memory access, the first counter increments by one. When it reaches 12 (or the end of the row, depending on where the memory access started and the exact implementation), it automatically resets itself and carries out a signal which increments the second 12 bit counter 704. Each time the first counter 702 reaches its endpoint (which represents the end of its particular data row in RAM), it increments on its carryout line 708 to the second counter 704. This carryout (i.e., incrementing the second counter) effectively changes the row in which the controller accesses data. In this way, the innovative system allows for fast page mode accessing to multiple address which span two or more rows, but without requiring the controller to compare the row address of the previous and next accesses to make sure it is in the proper row. In the innovative system, the data is preferably not read/written to the memory in bytes, but instead it is preferably sent in large blocks of data corresponding to lines of pixels on the display upon which the data will be displayed. This allows the relevant pixel display data to be in adjacent memory locations.

This arrangement is advantageous by allowing the pixel data for a particular screen shot to be accessed by the respective rows of pixels on the screens. All the pixels of a given row on the display are preferably accessed with a single starting point, and the row addresses searched for the data are only changed when necessary. This alleviates the need in a FPM system for checking that the row addresses of a previous and next data point are the same. Instead, the innovative system checks the same row for the data automatically, since an entire set of pixels (comprising a single row of pixels on the screen) is stored serially in the RAM with respect to addresses. Though such a set of data can span more than one row, the innovative system allows the controller to switch rows according to the counter rather than relying on the controller having to make the aforementioned row address comparison.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I claim:

1. A computer system, comprising:
a memory controller connected to a memory and designed to send data to a display device;
wherein the memory controller comprises first and second counters, the first counter controlling which column address is accessed by the memory controller, the second counter controlling which row address is accessed by the memory controller;
wherein each state of a plurality of counting states of the first counter corresponds to a column in the memory, and each state of a plurality of counting states of the second counter corresponds to a row in the memory; and
wherein the second counter increments when the first counter reaches a predetermined counting state.

2. The system of claim 1, wherein the predetermined counting state corresponds to a last column address location of a given row in the memory.

3. The system of claim 1, wherein the memory is dynamic random access memory.

4. A computer system, comprising:
a memory controller connected to access a memory device and to send data to a display device, the controller including a first linear counter having a plurality of counting states, and a second linear counter having a plurality of counting states;
wherein the counting states of the first counter each correspond to a column address in the memory and the counting states of the second counter each correspond to a row address in the memory;
wherein when the memory controller accesses the memory device at a first column address and a first row address, the first counter is set to a counting state corresponding to the first column address and the second counter is set to a counting state corresponding to the first row address;
wherein after each memory access by the memory controller, the first counter increments by one counting state;
wherein when the first counter reaches a predetermined counting state, the second counter increments by one counting state.

5. The system of claim 4, wherein the memory controller accesses the memory device at the location specified by the states of the first and second counters.

6. A method of accessing memory, comprising the steps of:
selecting a column address in a memory device according to a first counter having a plurality of counting states, each of the counting states corresponding to a column address in the memory device;
selecting a row address in the memory device according to a second counter having a plurality of counting states, each of the counting states corresponding to a row address in the memory device;
accessing the data corresponding to the column address and row address;
wherein with each successive memory access within a predetermined set of memory accesses, the first counter increments; and
wherein when the first counter reaches a predetermined counting state, the second counter automatically increments.

7. The method of claim 6, wherein the predetermined counting state corresponds to the last column address of a given row in the memory device.

8. The method of claim 6, wherein when the second counter increments, a memory controller accesses a different row in memory.

9. The method of claim 6, wherein data to be accessed within the memory device are graphics data, and wherein the graphics data are stored in the order used to display pixels on a display device.

10. A method of accessing memory, comprising the steps of:
correlating states of a first counter to memory column addresses;
correlating states of a second counter to memory row addresses;
accessing memory addresses according to a state of the first counter and a state of the second counter;
incrementing the first counter after a memory access;
incrementing the second counter after the first counter reaches a predetermined state.

11. The method of claim 10, wherein the accessed memory addresses contain graphics data.

12. The method of claim 10, wherein the predetermined state corresponds to the last column address of a row in memory.

13. A method of accessing memory, comprising the steps of:
accessing data which are stored serially in memory, wherein after each memory storage cell is accessed, a first counter is incremented;
incrementing a second counter when the first counter reaches a predetermined state;
wherein the first counter determines the column address of accessed data cells and wherein the second counter determines the row address of accessed data cells.

14. A method of accessing memory, comprising the steps of:
holding a row address pin of the memory in an access state;
placing a plurality of column address pins in access states sequentially one at a time such that memory cells associated with the row address pin and the plurality of column address pins are sequentially accessed;
wherein the row address for each memory access is not checked before each access begins.

15. The method of claim 14, wherein the row address pin held in an access state is determined by the state of a first counter; and
wherein the column address pin placed in an access state is determined by a second counter.

16. The method of claim 15, wherein the first counter increments only when the second counter reaches a predetermined state.

17. The method of claim 16, wherein the predetermined counting state corresponds with the first memory cell of a next row.
